(19) United States
(12) Patent Application Publication
(10) Pub. No.: US 2013/0169246 A1
(43) Pub. Date: Jul. 4, 2013

(54) LINEAR VOLTAGE REGULATING CIRCUIT ADAPTABLE TO A LOGIC SYSTEM

(71) Applicant: Wen-Pin Shao, Hsinchu City (TW)

(72) Inventor: Wen-Pin Shao, Hsinchu City (TW)

(73) Assignee: SKYMEDI CORPORATION, Hsinchu City (TW)

(21) Appl. No.: 13/338,682

(22) Filed: Dec. 28, 2011

(51) Int. Cl. G05F 1/10

(52) U.S. Cl. 323/266

(57) ABSTRACT

A linear voltage regulating circuit adaptable to a logic system is disclosed. A first linear voltage regulator receives an input voltage and a first reference voltage. A second linear voltage regulator has a load driving capability lower than the first linear voltage regulator, and the second linear voltage regulator receives the input voltage and a second reference voltage. An output node of the first linear voltage regulator and an output node of the second linear voltage regulator are directly connected at a single common output node. A single common capacitor is connected between the common output node and a ground.

### BACKGROUND OF THE INVENTION

1. Field of the Invention

The present invention generally relates to a linear voltage regulating circuit, and more particularly to a linear voltage regulating circuit with load regulation adaptable to a logic system.

2. Description of Related Art

A voltage regulator is an electrical circuit commonly adapted to maintain a constant voltage level. A linear voltage regulator is one type of the voltage regulator that operates in a linear region of a transistor.

As the linear voltage regulator is ordinarily designed to meet requirements of a high load current, a stable frequency response and a low dropout voltage, its consumed current cannot be effectively reduced. In that regard, an additional linear voltage regulator with lower load current and power consumption may be specifically used in a standby mode that has lower load to achieve load regulation. However, an extra output node and an extra passive device (e.g., a compensating capacitor) are needed, therefore increasing associated cost and circuit area. Moreover, an extra switch or switches are usually required to switch between the linear voltage regulators, further increasing the cost and circuit area.

For the foregoing reasons, a need has arisen to propose a novel linear voltage regulating circuit for overcoming the foregoing disadvantages without sacrificing the performance of the voltage regulation.

### SUMMARY OF THE INVENTION

In view of the foregoing, it is an object of the embodiment of the present invention, to provide a linear voltage regulating circuit that is capable of saving a significant amount of power consumption and/or reducing the cost and area due to the output node and the capacitor, while achieving voltage regulation and load regulation for the linear voltage regulating circuit.

According to one embodiment, a linear voltage regulating circuit includes a first linear voltage regulator, a second linear voltage regulator, a single common output node and a single common capacitor. The first linear voltage regulator is coupled to receive an input voltage and a first reference voltage. The second linear voltage regulator has a load driving capability lower than the first linear voltage regulator, and the second linear voltage regulator is coupled to receive the input voltage and a second reference voltage. An output node of the first linear voltage regulator and an output node of the second linear voltage regulator are directly connected at the single common output node. The single common capacitor is connected between the common output node and a ground.

### BRIEF DESCRIPTION OF THE DRAWINGS

FIG. 1 shows a block diagram of a linear voltage regulating circuit with load regulation adaptable to a logic system, according to one embodiment of the present invention;

FIG. 2 shows a detailed circuit of the first linear voltage regulator of FIG. 1;

FIG. 3 shows a detailed circuit of the second linear voltage regulator of FIG. 1; and

FIG. 4 shows another detailed circuit of the second linear voltage regulator of FIG. 1.

### DETAILED DESCRIPTION OF THE INVENTION

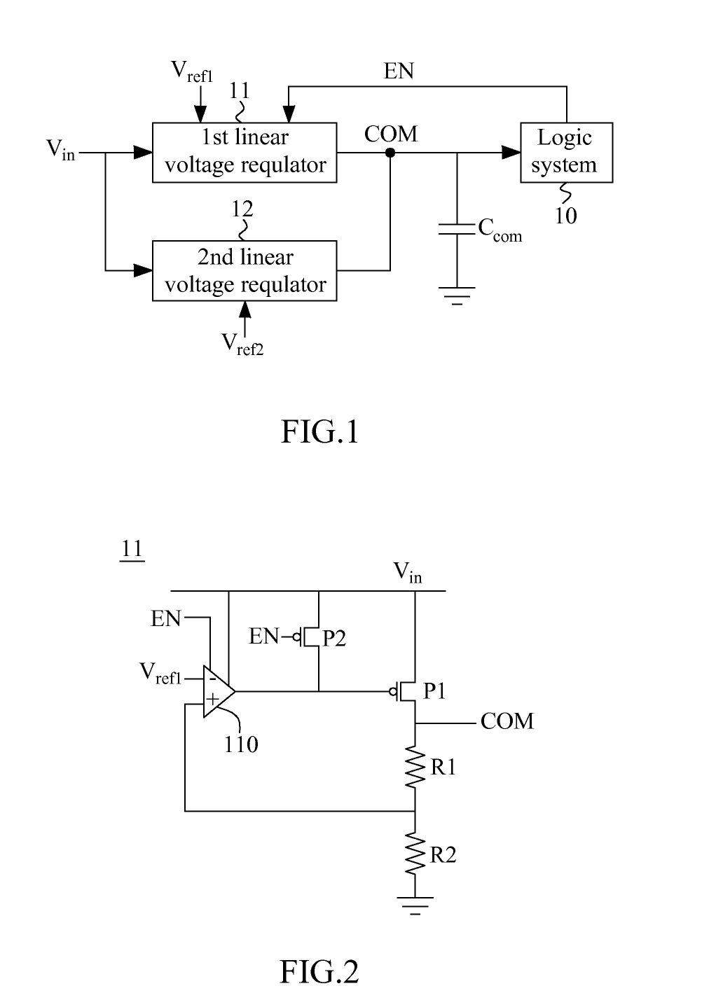

FIG. 1 shows a block diagram of a linear voltage regulating circuit with load regulation adaptable to a logic system 10, according to one embodiment of the present invention. The logic system 10 may operate in either a normal (operating) mode with full power, or a low-power mode (such as a standby mode) with reduced power.

In the embodiment, the linear voltage regulating circuit includes a first linear voltage regulator 11 and a second linear voltage regulator 12. The first linear voltage regulator 11 is configured to have a load driving capability (or load current) higher than the second linear voltage regulator 12. For example, the load current of the first linear voltage regulator 1.1 is tens or hundreds of milliamperes (mA), and the load current of the second linear voltage regulator 12 is just a couple of milliamperes. Alternatively speaking, the power consumed in the first linear voltage regulator is generally higher than that in the second linear voltage regulator 12, in the normal mode. The first or second linear voltage regulator 11/12 may be, but not limited to, a low-dropout (LDO) regulator, which requires an input voltage at least some predetermined amount a dropout voltage) higher than a regulated output voltage.

As shown in FIG. 1, both the first linear voltage regulator 11 and the second linear voltage regulator 12 receive the input voltage Vᵢₙ. Further, the first linear voltage regulator 11 and the second linear voltage regulator 12 receive a first reference voltage V_{ref1} and a second reference voltage V_{ref2}, respectively. The first reference voltage V_{ref1} and the second reference voltage V_{ref2} may be, but unnecessarily, the same. In one embodiment, the first reference voltage V_{ref1} or the second reference voltage V_{ref2} may be, but not limited to, a bandgap reference voltage (i.e., the bandgap of silicon) generated by a bandgap reference generating circuit (not shown).

According to one aspect of the embodiment, an output node of the first linear voltage regulator 11 and an output node of the second linear voltage regulator 12 are directly connected at a common output node COM. The (first) output voltage of the first linear voltage regulator 11 is substantially the same as the (second) output voltage of the second linear voltage regulator 12, in the normal mode. Moreover, a common capacitor C_{com}, which acts as a compensation capacitor to stabilize the regulated output voltage, is connected between the common output node COM and a ground. In the specification, the term “ground” may be referring to a reference point, in a circuit, from which other voltages are measured, or referring to a common return path for an electric current. Accordingly, the voltage at the ground may, for example, be a zero, a positive, or a negative value.

Compared to the conventional voltage regulating circuit, the present embodiment utilizes a single output node COM and the associated single common capacitor C_{com}, rather than using multiple output nodes and multiple capacitors respectively coupled to the logic system as in the conventional voltage regulating circuit. Therefore, the cost and area due to the output node and the capacitor may be substantially reduced.

According to another aspect of the embodiment, the first linear voltage regulator 11 may be disabled (i.e., disconnected from the logic system 10) by a de-asserted enable signal EN issued by the logic system 10 in the low-power mode (such as a standby mode), therefore saving a significant amount of power consumption. In the low-power mode, only a minor portion, for example a realtime clock (RTC) circuit 101, of the logic system 10 is still operative. The operation of the RTC circuit 101 is maintained by the second linear voltage regulator 12 in the low-power mode. The operative RTC circuit 101 is required to wake up (or restore) the logic system 10, for example, from the standby mode whenever the logic system 10 needs to enter the normal mode. Upon entering the normal mode, the logic system 10 issues an asserted enable signal EN to the first linear voltage regulator 11, therefore enabling and connecting with the first linear voltage regulator 11, such that the first linear voltage regulator 11 may provide the output voltage with sufficient or higher load driving capability (or load current) to the logic system 10. In the embodiment, the de-asserted enable signal and the asserted enable signal are implemented by a single control signal with respective voltage levels.

FIG. 2 shows a detailed circuit of the first linear voltage regulator 11 of FIG. 1. The first linear voltage regulator 11 of the embodiment includes an operational (OP) amplifier 110, a p-type metal-oxide-semiconductor (PMOS) transistor P1, and a voltage divider made up of a first resistor R1 and a second resistor R2 connected in series. Specifically, a gate of the PMOS transistor P1 is coupled to an output of the OP amplifier 110. The source and drain, of the PMOS transistor P1 are coupled between the input voltage Vᵢₙ and the common output node COM, respectively. The two ends of the voltage divider (R1 and R2) are coupled between the common output node COM and the ground respectively, and its derived divided voltage is then fed back to a non-inverted input node (+) of the OP amplifier 110, with an inverted input node (−) receiving the first reference voltage V_{ref1}. According to the configuration of the first linear voltage regulator 11 as described above, the OP amplifier 110 drives the PMOS transistor P1 with more current when the divided voltage of the voltage divider (R1 and R2) at the non-inverting input node (+) drops below the first reference voltage V_{ref1} at the inverting input node (−), thereby achieving voltage regulation for the first linear voltage regulator 11.

According to one aspect of the embodiment as mentioned above, the first linear voltage regulator 11 further includes an enable transistor P2, for example, a PMOS transistor with a source and a drain, connected between the input voltage Vᵢₙ and the gate of the PMOS transistor P1 respectively, and a gate of the enable transistor P2 controlled by the enable signal EN. When the enable signal EN is de-asserted (e.g., becomes low voltage level), the enable transistor P2 becomes conductive and the gate of the PMOS transistor P1 is thus pulled to the input voltage Vᵢₙ, thereby inactivating the PMOS transistor P1 and disconnecting the first linear voltage regulator 11 from the logic system 10. The OP amplifier 110 may further include an enable control node coupled with and controlled by the enable signal EN. When the enable signal EN is de-asserted, the OP amplifier 110 is disabled (or shut off) such that the current consumed from the input voltage Vᵢₙ to the OP amplifier 110 may be substantially reduced to approximately zero a number of nanoamperes (nA)).

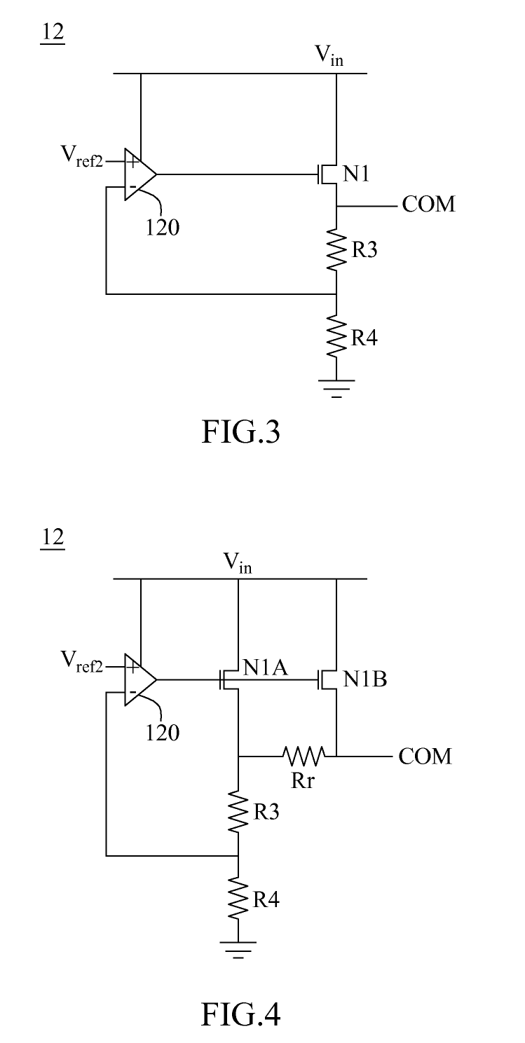

FIG. 3 shows a detailed circuit of the second linear voltage regulator 12 of FIG. 1. The second linear voltage regulator 12 of the embodiment includes an operational (OP) amplifier 120, an n-type metal-oxide-semiconductor (NMOS) transistor N1 and a voltage divider made up of a third resistor R3 and a fourth resistor R4 connected in series. Specifically, a gate of the NMOS transistor N1 is coupled to an output of the OP amplifier 120. The source and drain, of the NMOS transistor N1 are coupled between the input voltage Vᵢₙ and the common output node COM, respectively. The two ends of the voltage divider (R3 and R4) are coupled between the common output node COM and the ground respectively, and its derived divided voltage is then fed back to an inverted input node (−) of the OP amplifier 120, with a non-inverted input node (+) receiving the second reference voltage V_{ref2}. According to the configuration of the second linear voltage regulator 12 as described above, the OP amplifier 120 drives the NMOS transistor N1 with more current when the divided voltage of the voltage divider (R3 and R4) at the inverting input node (−) drops below the second reference voltage V_{ref2} at the non-inverting input node (+), thereby achieving voltage regulation for the second linear voltage regulator 12. It is noted that no enable transistor (like the enable transistor P2 in FIG. 2) is used in the second linear voltage regulator 12 in the embodiment, indicating that the second linear voltage regulator 12 may operate in either the normal mode or the low-power mode.

In an embodiment, the NMOS transistor N1 may be a native NMOS transistor that has a nearly zero threshold voltage. The use of the native NMOS transistor in the embodiment may be better adapted to a low-voltage operational amplifier, thereby alleviating design complexity in the low-voltage application.

FIG. 4 shows another detailed circuit of the second linear voltage regulator 12 of FIG. 1. The circuit configuration of FIG. 4 is similar to that of FIG. 3 with the following exceptions. The NMOS transistor N1 of FIG. 3 is replaced with parallel-connected first NMOS transistor N1A and second NMOS transistor N1B. Specifically, the gates of the first and second. NMOS transistors (N1A and N1B) are coupled together and connected to an output of the OP amplifier 120; the drains of the first and second NMOS transistors (N1A and N1B) are coupled to the input voltage Vᵢₙ. The source of the first NMOS transistor N1A is coupled to one end of the voltage divider (R3 and R4), with the other end of the voltage divider (R3 and R4) coupled to the ground. The source of the second. NMOS transistor N1B is coupled to the common output node COM. The first and second NMOS transistors (N1A and N1B) are configured, e.g., by adjusting the amount of their respective fingers, such that the current flowing through the channel of the second NMOS transistor N1B is a multiple of the current flowing through the channel of the first NMOS transistor N1A. In an ideal situation, the sources of the first and second. NMOS transistors (N1A and N1B) should be at the same voltage level. Similarly to the embodiment of FIG. 3, the first and second. NMOS transistors (N1A and N1B) may be native NMOS transistors that have a nearly zero threshold voltage. Accordingly, the native NMOS transistors in the embodiment may be better adapted to a low-voltage operational amplifier, thereby alleviating design complexity in the low-voltage application.

According to a further aspect of the embodiment, an internal regulating resistor Rᵣ is further coupled between the sources of the first and second NMOS transistors (N1A and N1B). When the sources of the first and second NMOS transistors (N1A and N1B) are not at the same voltage level as supposed to be, a current is thus incurred in the regulating resistor Rᵣ. Therefore, the OP amplifier 120 drives the first NMOS transistor N1A with more current due to the incurred current in the regulating resistor Rᵣ, when the output voltage at the common output node COM drops, thereby achieving voltage regulation for the second linear voltage regulator 12 and load regulation for the entire linear voltage regulating circuit.

Although specific embodiments have been illustrated and described, it will be appreciated by those skilled in the art that various modifications may be made without departing from the scope of the present invention, which is intended to be limited solely by the appended claims.

What is claimed is:

1. A linear voltage regulating circuit adaptable to a logic system, comprising:
a first linear voltage regulator coupled to receive an input voltage and a first reference voltage;
a second linear voltage regulator having a load driving capability lower than the first linear voltage regulator, the second linear voltage regulator being coupled to receive the input voltage and a second reference voltage;
a single common output node, at which an output node of the first linear voltage regulator and an output node of the second linear voltage regulator are directly connected; and
a single common capacitor connected between the common output node and a ground.

2. The circuit of claim 1, wherein the first or the second linear voltage regulator comprises a low-dropout (LDO) regulator.

3. The circuit of claim 1, wherein the first reference voltage or the second reference voltage is a bandgap reference voltage.

4. The circuit of claim 1, wherein the logic system operates either in a normal mode or a low-power mode.

5. The circuit of claim 4, wherein the low-power mode is a standby mode.

6. The circuit of claim 4, wherein the first linear voltage regulator is disabled by a de-asserted enable signal issued by the logic system in the low-power mode.

7. The circuit of claim 6, wherein the first linear voltage regulator is enabled by an asserted enable signal issued by the logic system in the normal mode.

8. The circuit of claim 7, wherein the first linear voltage regulator comprises:
an operational (OP) amplifier having a non-inverted input node and an inverted input node receiving the first reference voltage;
a p-type metal-oxide-semiconductor (PMOS) transistor having a gate coupled to an output of the OP amplifier, wherein a source and a drain, of the PMOS transistor are coupled between the input voltage and the common output node respectively; and
a voltage divider configured to generate a divided voltage, wherein two ends of the voltage divider are coupled between the common output node and the ground respectively, and the divided voltage is fed back to the non-inverted input node.

9. The circuit of claim 8, wherein the first linear voltage regulator further comprises:
an enable transistor having a source and a drain connected between the input voltage and the gate of the PMOS transistor respectively, wherein a gate of the enable transistor is controlled by the asserted and the de-asserted enable signals.

10. The circuit of claim 9, wherein the OP amplifier further comprises an enable control node controlled by the de-asserted enable signal, which disables the OP amplifier.

11. The circuit of claim 1, wherein the second linear voltage regulator comprises:
an operational (OP) amplifier having an inverted input node and a non-inverted input node receiving the second reference voltage;
an n-type metal-oxide-semiconductor (NMOS) transistor having a gate coupled to an output of the OP amplifier, wherein a source and a drain of the NMOS transistor are coupled between the input voltage and the common output node respectively; and
a voltage divider configured to generate a divided voltage, wherein two ends of the voltage divider are coupled between the common output node and the ground respectively, and the divided voltage is fed back to the inverted input node.

12. The circuit of claim 11, wherein the NMOS transistor is a native NMOS transistor.

13. The circuit of claim 1, wherein the second linear voltage regulator comprises:
an operational (OP) amplifier having an inverted input node and a non-inverted input node receiving the second reference voltage;
a first NMOS transistor and a second NMOS transistor connected in parallel, wherein gates of the first and the second NMOS transistors are coupled to an output of the OP amplifier; drains of the first and the second NMOS transistors are coupled to the input voltage; a source of the second NMOS transistor is coupled to the common output node; and
a voltage divider configured to generate a divided voltage, wherein two ends of the voltage divider are coupled between a source of the first NMOS transistor and the ground respectively, and the divided voltage is fed back to the inverted input node.

14. The circuit of claim 13, wherein the first and the second NMOS transistors are configured such that a current flowing through a channel of the second NMOS transistor is a multiple of a current flowing through a channel of the first NMOS transistor, thereby the sources of the first and the second NMOS transistors have a same voltage level.

15. The circuit of claim 13, wherein the first and the second NMOS transistors are native NMOS transistors.

16. The circuit of claim 13, wherein the second linear voltage regulator further comprises:
an internal regulating resistor coupled between the sources of the first and the second NMOS transistors.
